(19) United States
(12) Patent Application Publication
(10) Pub. No.: US 2025/0115099 A1
(43) Pub. Date: Apr. 10, 2025

(54) THERMAL MANAGEMENT DEVICE

(71) Applicant: VALEO KLIMASYSTEME GMBH, Bad Rodach (DE)

(72) Inventors: Andreas Fiene, Bad Rodach (DE); Satyam Hedaoo, Bad Rodach (DE)

(73) Assignee: VALEO KLIMASYSTEME GMBH, Bad Rodach (DE)

(21) Appl. No.: 18/836,004

(22) PCT Filed: Feb. 7, 2023
(86) PCT No.: PCT/EP2023/053007

§ 371 Date: Aug. 6, 2024

(30) Foreign Application Priority Data
Feb. 22, 2022 (DE) 10 2022 104 197.2

(51) Int. Cl. B60H 1/32; B60H 1/00

(52) U.S. Cl. CPC B60H 1/3229; B60H 1/00485

(57) ABSTRACT

A thermal management device includes a first connecting element, a second connecting element, and a hollow volume between the first and second ports. The first connecting element includes a first base element with a first side and a second side, at least one first port on the first side and one second port on the second side. The second connecting element includes a second base element with a third side and a fourth side, at least one third port on the third side, and a fourth port on the fourth side. The thermal management device also includes a second hollow volume between the third and fourth sides. The first and second connecting elements are positioned at an angle relative to each other such that a volume for the attachment of a thermal management component to the first or second connecting element is formed.

### TECHNICAL FIELD OF THE INVENTION

The invention relates to a thermal management device, a thermal management system with the thermal management device, a method for assembling the thermal management system, and a method for producing the thermal management device.

### BACKGROUND OF THE INVENTION

Modern vehicles have thermal management systems such as cooling/heating circuits, inter alia in order to provide comfort functions for the occupants and in order to ensure required temperature control of components such as drive components. Cooling/heating circuits are composed substantially of thermal management components such as pumps, valves and heat exchangers, and of components which serve for conducting a fluid fluid and which fluidically connect the thermal management components to one another. The fluid is moved back and forth between the thermal management components in a circuit by means of the fluid-conducting components, and serves for exchanging heat between the thermal management components.

In order to allow for the demand for reducing structural space in modern vehicles, thermal management systems are of increasingly compact design. Here, a crucial role is played not only by the reduction in size of the thermal management components but in particular also by the compact form of the fluid-conducting components and the arrangement of the thermal management components with respect to one another and with respect to the fluid-conducting components. Designing all fluid-conducting components of a cooling/heating circuit as a fluid-conducting integral component, hereinafter also referred to as connecting element, allows a particularly space-saving design of cooling/heating circuits. The thermal management components are in this case attached to the fluid-conducting integral component.

In hybrid and electric vehicles in particular, there is furthermore a demand to exchange thermal energy between different cooling/heating circuits, that is to say to create a thermal connection between the different cooling/heating circuits. By exchanging thermal energy between a cooling/heating circuit that serves for controlling the temperature of the vehicle interior compartment and a further cooling/heating circuit that serves for controlling the temperature of the drive components, additional functions can be implemented, and existing temperature control demands can be better satisfied. For example, it is thus possible for an electrical auxiliary heater that is responsible for warming the incoming air in the cooling/heating circuit for controlling the temperature of the interior compartment to also be utilized for warming the traction battery, which is arranged in a further cooling/heating circuit, in the presence of low outside temperatures.

By exchanging thermal energy between different heating/cooling circuits, it is thus also possible for components to be omitted, and for costs and energy usage to be reduced.

If the heating/cooling circuits that are to be thermally connected are equipped with fluid-conducting integral components, the transfer of thermal energy between the heating/cooling circuits poses a particular challenge. To reduce structural space and to reduce flow and heat losses, it is advantageous to position the fluid-conducting integral components spatially as close together as possible. It is thus sought to arrange the fluid-conducting integral components spatially as close together as possible, and to ensure the exchange of thermal energy. At the same time, sufficient structural space must be kept available in order that the thermal management components of the cooling/heating circuits in question can be arranged as close as possible to the fluid-conducting integral components and can be connected thereto. The spatially close arrangement of multiple fluid-conducting integral components thus gives rise to the problem that the available structural space for the thermal management components that are to be arranged in each cooling/heating circuit is further reduced.

The prior art discloses solutions for the arrangement of fluid-conducting integral components of thermally connected cooling/heating circuits and of the thermal management components thereof. The proposed solutions are based on the fluid-conducting integral components being arranged in parallel, and the fluid-conducting integral components being populated with thermal management components in each case on one side. The prior art however does not disclose any solution for a structural-space-optimized arrangement of the fluid-conducting integral components with respect to one another and of the thermal management components of the heating/cooling circuits, and in particular also does not disclose any arrangement that allows multiple fluid-conducting integral components to be populated with thermal management components on multiple sides.

### SUMMARY OF THE INVENTION

The invention is based on the technical problem of providing a thermal management system for the structural-space-optimized arrangement of multiple fluid-conducting integral components and of the thermal management components on the fluid-conducting integral components.

The present document describes a thermal management device for a vehicle, in particular an electric or hybrid vehicle. The thermal management device comprises a first connecting element and a second connecting element. The first connecting element comprises a first base element with a first side and a second side, and at least one first port, arranged on the first side or the second side, and one second port, arranged on the first side or on the second side. The first connecting element furthermore comprises at least one first hollow volume that extends between the at least first port and second port.

The second connecting element comprises a second base element with a third side and a fourth side, and at least one third port, arranged on the third side or on the fourth side, and one fourth port, arranged on the third side or on the fourth side. The second connecting element furthermore comprises at least one second hollow volume that extends between the at least third port and fourth port.

The first connecting element and the second connecting element are positioned at an angle with respect to one another, such that an at least partially delimited volume for the attachment of at least one thermal management component to the first connecting element or the second connecting element is defined.

Thermal management components can be positioned in a space-saving manner in the volume defined by the two connecting elements and can be attached to the ports of the connecting elements. The angled arrangement of the first connecting element and the second connecting element has the effect that both the first side and second side of the first connecting element and the third side and fourth side of the second connecting element are accessible. The area of the connecting elements to which thermal management components can be attached is thus maximized. Thermal management components can thus be attached to two sides of each connecting element. This yields more freedom for the design of the connecting elements and arrangement of the thermal management components on the connecting elements. A space-saving arrangement of the thermal management components on the connecting elements can thus be achieved, whereby the unit composed of thermal management device and attached thermal management components can be of more space-saving design. The fact that the connecting elements are accessible from all sides means firstly that the assembly of the thermal management device and the attachment of the thermal management components can be made easier. Secondly, the exchange of components during the use of the vehicle can also be made easier, for example in the event of a defect of a thermal management component.

Preferably, at least one of the ports allows the attachment of at least one thermal management component in order to position the thermal management component(s) in a fluid path defined by the hollow volumes.

Some thermal management components must be positioned in the fluid path in order to be able to perform their function. For example, a pump must be positioned in the fluid path, this to say in this case traversed by a flow of the fluid, in order to be able to pump the fluid. Valves must likewise be positioned in the fluid path in order to be able to control and regulate the flow of the fluid in the fluid path. Some temperature sensors and/or pressure sensors also require direct contact with the fluid in order to be able to correctly detect the temperature and/or the pressure of the fluid. Further thermal management components such as compressors or particular designs of heat exchangers likewise need to be positioned in the fluid path. The possibility of positioning thermal management components at the ports in the fluid path thus enables these thermal management components to function optimally.

Preferably, at least one of the ports allows the attachment of at least one thermal management component in order to position the thermal management component(s) separately from the fluid path defined by the hollow volumes and in order to exchange thermal energy with a fluid in the hollow volumes.

Further thermal management components exist which do not need to be directly positioned in the fluid path, that is to say do not need to be in direct contact with or traversed by a flow of the fluid, in order to perform their function. It can suffice for these thermal management components to be able to exchange thermal energy with the fluid in order to perform their function in a cooling/heating circuit or thermal management system. Certain types of temperature sensors and heat exchangers do not need to be in direct contact with the fluid but also function as long as the exchange of thermal energy with the fluid is ensured. By virtue of ports being provided which allow the thermal management components to be attached to the connecting elements without being in direct contact with the fluid in the fluid path, these thermal management components can also optimally perform their function. For this purpose, the ports must be designed so as to ensure the required exchange of thermal energy between a thermal management component that is to be attached and the fluid flowing in the flow path.

Preferably, one of the first port and the second port is arranged on the first side, and the other of the first port and the second port is arranged on the second side.

An arrangement of ports on both sides of the first connecting element has the effect that the space available for the attachment of the thermal management components, and the freedom for the arrangement of the thermal management components that are to be attached, are increased.

Preferably, one of the third port and the fourth port is arranged on the third side and the other of the third port and the fourth port is arranged on the fourth side.

An arrangement of ports on both sides of the second connecting element has the effect that the space available for the attachment of the thermal management components, and the freedom for the arrangement of the thermal management components that are to be attached, are increased.

The first connecting element and the second connecting element are preferably arranged orthogonally with respect to one another.

The right-angled arrangement of the two connecting elements with respect to one another allows optimized utilization of the space that is available for the arrangement and attachment of the thermal management components. Conventional thermal management components are often designed with straight surfaces and edges, and often with right-angled shapes. Furthermore, conventional thermal management components are often designed such that, when attached to a connecting element, they are arranged at right angles with respect to the connecting element. A thermal management component attached for example to the first connecting element can thus be arranged substantially parallel to the second connecting element, because the two connecting elements are arranged at right angles with respect to one another. Said thermal management component can thus, if required, be arranged as close as possible to the second connecting element without unduly wasting structural space. An angled arrangement of the two connecting elements with respect to one another would also result in an angle between the thermal management component attached to the first connecting element and the second connecting element. In this case, it would not be possible for the thermal management component to be arranged as close to the second connecting element, as a result of which it would not be possible to utilize structural space. The right-angled orientation of the two connecting elements with respect to one another thus allows the available structural space to be optimally utilized for the attachment and arrangement of the thermal management components.

Preferably, the first base element is of plate-like form and extends in a first plane, and in particular, the first base element is of plate-like form with the integrated fluid path that is defined by the first hollow volume that extends in the first plane. Alternatively or in addition, the second base element is of plate-like form and extends in a second plane, and in particular, the second base element is of plate-like form with the integrated fluid path that is defined by the second hollow volume that extends in the second plane.

By means of a plate-like design of the first and/or second base element with integrated hollow volumes as fluid paths within the base element, the fluid paths required for connecting all required thermal management components of the cooling/heating circuit can be accommodated in the most space-saving manner possible in a component. The plate-like form of the first and/or second base element also makes it easier for the thermal management components that are to be attached to the connecting elements to be arranged in a structural-space-optimized manner. Plate-like base elements give rise to cuboidal volumes in which the thermal management components can be arranged. This ensures maximum freedom for the arrangement and attachment of the thermal management components.

Preferably, at least one of the ports is attached to the first base element or the second base element, and/or at least one of the ports is an integral element with the first base element or the second base element.

As ports for the attachment of the thermal management components to the connecting parts, it is optionally possible to use standardized components that are attached to the base elements. This ensures that a large selection of thermal management components with attachment elements corresponding to the standard can be attached to the ports of the connecting parts. The ports may also be formed integrally with the base element and produced with the base elements in one production process, for example by 3D printing or casting. Production costs and time can be reduced in this way.

Preferably, the first connecting element and the second connecting element are connected to one another.

By virtue of the first connecting element and the second connecting element being connected, the assembly of the thermal management device and the installation into and removal from the vehicle can be made easier, because the thermal management device can be handled as one component. Installation into or removal from a vehicle can thus be performed in one working step.

Preferably, the first connecting element comprises a fifth port and the second connecting element comprises a sixth port, wherein the fifth port and the sixth port are fluidically connected.

A fluidic connection between the two connecting elements can be created using the fifth and sixth ports. Thermal coupling between different heating/cooling circuits can thus be implemented. For example, the first connecting element can serve for implementing a first cooling circuit, whilst the second connecting element serves for implementing a second cooling circuit. Owing to a fluidic connection between the first and the second connecting element, it is for example possible for a heat exchanger to be attached to one of the two connecting elements such that the exchange of thermal energy between the first cooling circuit and the second cooling circuit can be realized. In this way, additional functions can be implemented, and components can be omitted.

Preferably, the first connecting element and the second connecting element are an integral element.

The production of the connecting elements can be made easier by virtue of the first connecting element and the second connecting element being designed as an integral component. This can lead to a reduction in production costs and production time, because both connecting elements can be produced in one production step, and the required connection of the first and second connecting elements can also optionally be omitted.

Preferably, at least two thermal management components are attached to at least two of the ports, and the thermal management components are components such as a valve, a pump, a heat exchanger, a temperature sensor or a pressure sensor.

By virtue of said components being attached to the first connecting element and the second connecting element, the first cooling/heating circuit and the second cooling/heating circuit can be implemented with a large number of functions.

Preferably, at least one of the connecting elements comprises at least one of the thermal management components on each of its sides.

An arrangement of thermal management components on both sides of the first and/or second connecting element has the effect that the structural space available for the attachment of the thermal management components, and the freedom for the arrangement of the thermal management components that are to be attached, are increased.

Preferably, the first connecting element is composed of aluminium, and/or the second connecting element is composed of a polymer.

Cooling/heating circuits perform different functions and must accordingly satisfy different demands. For example, there are large differences in the types of components that are to be cooled/heated and in the quantities of thermal energy that are to be transported. Accordingly, different fluids for circulation in the cooling/heating circuits are selected, and the pressures prevailing in the cooling/heating circuits also greatly vary. In order to satisfy different demands, for example with regard to pressures that are to be tolerated or chemical resistance with respect to particular fluids, it can be necessary or expedient to produce the connecting elements from different materials. The first connecting element may for example be produced from aluminium in order to be able to realize higher pressures of the fluid, for example for a cooling/heating circuit for drive components in which high demands are placed on the quantities of thermal energy being transported. The second connecting element may be produced from a polymer material in order to realize inexpensive production whilst simultaneously satisfying the relatively low pressure demands of, for example, a cooling/heating circuit for climate control of an interior compartment.

The present document furthermore describes a thermal management system. The thermal management system comprises the thermal management device and at least one of a first thermal management component attached to the first port, a second thermal management component attached to the second port, a third thermal management component attached to the third port, and a fourth thermal management component attached to the fourth port. The thermal management components are components such as a valve, a pump, a heat exchanger, a temperature sensor or a pressure sensor.

The present document furthermore describes a method for assembling the thermal management system. The method comprises the steps of attaching the first thermal management component to the first port, attaching the second thermal management component to the second port, attaching the third thermal management component to the third port, attaching the fourth thermal management component to the fourth port, and connecting the first connecting element and the second connecting element.

Since the thermal management components are firstly attached to the first connecting element and to the second connecting element in each case, it can be made easier for the thermal management components to be attached, because the attachment operation is not influenced by the respective other connecting element or by the thermal management components attached to said connecting element. The first connecting element and the second connecting element can subsequently be connected to one another together with the respectively attached thermal management components.

The present document furthermore describes a method for producing the thermal management device. The method comprises the steps of providing a first base element with at least one first hollow volume, providing a second base element with at least one second hollow volume, generating a first port and a second port on a first side or a second side of the first base element, generating a third port and a fourth port on a third side or a fourth side of the second base element, and arranging the connecting elements in order to define an at least partially delimited volume for the attachment of at least one thermal management component to at least one of the ports.

### DESCRIPTION OF THE FIGURES

FIG. 1 shows a first perspective view of a first connecting element.

FIG. 2 shows a second perspective view of the first connecting element.

FIG. 3 shows a first perspective view of a second connecting element.

FIG. 4 shows a second perspective view of the second connecting element.

FIG. 5 shows a first perspective view of a thermal management system.

FIG. 6 shows a second perspective view of the thermal management system.

FIG. 7 shows a flow diagram of a method for assembling the thermal management system.

FIG. 8 shows a flow diagram of a method for producing the thermal management device.

### DETAILED DESCRIPTION OF THE INVENTION

The invention will now be described on the basis of the drawings. It is assumed that the embodiments and aspects of the invention as described here are merely examples and in no way limit the scope of protection of the claims. The invention is defined by the claims and their equivalents. It is assumed that features of one aspect or of one embodiment of the invention may be combined with a feature of another aspect or other aspects and/or embodiments of the invention.

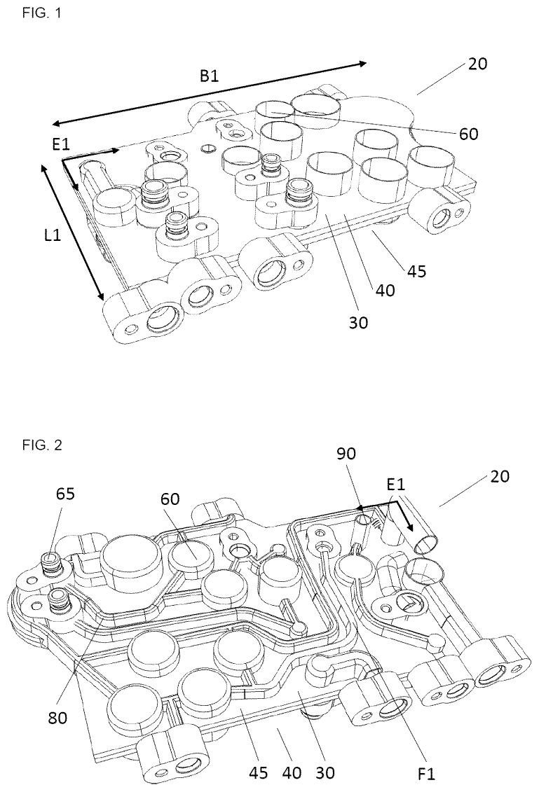

FIG. 1 shows a first perspective view of the first connecting element 20. The first connecting element 20 comprises a first base element 30. The first base element 30 is designed as a cuboidal and plate-like component. The first base element 30 extends in the direction of a first plane E1 and has a first width B1 and a first length L1. The extent of the first base element 30 in a direction perpendicular to the first plane E1 is considerably smaller than the extent of the first base element 30 in the first plane E1. The first base element 30 may also have a shape other than the cuboidal shape, for example a disc-like shape.

The first base element 30 may alternatively merely have the outline of a cuboid or of some other shape, wherein the first base element 30 may, in parts, have apertures. The first base element 30 may alternatively also have an outline other than the outline of a geometrical shape, that is to say may have a free-form design. This may be advantageous in particular in order to save material and thus costs and weight.

The first base element 30 has two surfaces that are oriented parallel to the first plane E1. One of said two surfaces is situated on a first side 40 of the first base element 30, and the other of the two surfaces is situated on a second side 45 of the first base element 30. The first side 40 is situated on that side of the first base element 30 which is situated opposite the second side 45.

The first connecting element 20 comprises a first hollow volume 80 (see FIG. 2). The first hollow volume 80 is designed in the form of an elongate hollow volume within the first base element 30. The first hollow volume 80 has a circular cross section and has an elongate extent in the first plane E1. The first hollow volume 80 may also have some other cross section, and the cross section of the first hollow volume 80 may vary along the extent in the first plane E1.

The first hollow volume 80 extends in the first plane E1 in a meandering manner. The first hollow volume 80 may have a very limited, even approximately punctiform, extent in the first plane E1, or may extend in elongate or areal form over a major part of the first base element 30 in the first plane E1.

The first hollow volume 80 is suitable for receiving a medium such as a gas or a first fluid F1. The first hollow volume 80 thus forms a fluid path or a line for receiving the first fluid F1. The first fluid F1 can flow in the first hollow volume 80.

The first fluid F1 is for example a refrigerant which is suitable for use in a cooling/heating circuit and which can absorb thermal energy when at relatively low temperature and relatively low pressure and can release thermal energy when at relatively high temperature and relatively high pressure. The first fluid F1 is for example ammonia, hydrocarbons, carbon dioxide or a synthetic refrigerant. The first fluid F1 may also be some other material that can absorb and release thermal energy, for example also a coolant.

Aside from the first hollow volume 80, the first connecting element 20 may comprise further hollow volumes that may be separate from one another or connected to one another.

The first connecting element 20 furthermore comprises a first port 60 that is arranged on the first side 40 of the first base element 30. The first port 60 allows a thermal management component 110, such as a valve, a compressor, a heat exchanger, a temperature sensor or a pressure sensor, to be attached to or installed on the first port 60.

The first port 60 provides access to the first hollow volume 80, such that a thermal management component 110 attached to the first port 60 can be positioned in the fluid path defined by the first hollow volume 80. The thermal management component 110 can thus be fluidically connected by means of the first port 60 to the first hollow volume 80, such that the first fluid F1 that is conducted in the first hollow volume 80 can reach or enter the thermal management component 110. For example, a valve may be attached to the first port 60 in order to influence the flow of the first fluid F1 in the first hollow volume 80. It would also be possible, for example, for a heat exchanger to be connected by means of the first port 60 to the first hollow volume 80, such that the first fluid FI can flow through the heat exchanger.

The first port 60 comprises a sealing element in order to prevent an escape of the first fluid F1 between the first base element 30 and a thermal management component 110 that is to be attached. The sealing element at the first port 60 may also be omitted. It is alternatively also possible for the thermal management component 110 to comprise a sealing element in order to seal off the thermal management component 110 with respect to the first base element 30.

The first port 60 allows not only the fluidic connection of the thermal management component 110 to the first hollow volume 80 but also the mechanical fastening of the thermal management component 110 to the first port 60. The thermal management component 110 may be fastened to the first port 60 for example using a fastening means such as a screw, or by way of a plug-in connection.

The first port 60 may alternatively be designed such that the thermal management component 110 that is to be attached is connected in thermally conductive fashion to the first fluid F1, but is not positioned in the fluid path defined by the first hollow volume 80. In this case, there is no fluidic connection between the thermal management component 110 attached to the first port 60 and the first hollow volume 80. The thermal management component 110 therefore does not come into direct contact with the first fluid F1 in the first hollow volume 80, but can exchange thermal energy with the first fluid F1. The first port 60 in this embodiment may also provide mechanical fastening of the thermal management component 110 to the first base element 30, for example using a fastening element such as a screw, or by way of a plug-in connection.

FIG. 2 shows a second perspective view of the first connecting element 20. The first connecting element 20 furthermore comprises a second port 65 that is arranged on the second side 45 of the first base element 30. The second port 65 allows a further thermal management component 110, such as a valve, a compressor, a heat exchanger, a temperature sensor or a pressure sensor, to be attached to or installed on the second port 65. As already described for the first port 60, the second port 65 allows the thermal management component 110 that is to be attached to be positioned in the fluid path formed by the first hollow volume 80. Alternatively, analogously to the statements made regarding the first port 60, the second port 65 may be designed such that the thermal management component 110 that is to be attached is connected in thermally conductive fashion to the first fluid F1 but is not positioned in the fluid path defined by the first hollow volume 80.

The first connecting element 20 may have further ports which are arranged at different locations on the first side 40 and/or the second side 45 and which are designed analogously to the statements made regarding the first port 60 and second port 65. The first connecting element 20 may furthermore have further ports that are arranged on one of the narrow surfaces of the first base element 30. Alternatively, the first connecting element 20 may only have ports that are all arranged only on one of the first side 40 and the second side 45. The thermal management components 110 that are to be attached to the ports are in this case attached only to one of the first side 40 and the second side 45. This can yield structural space advantages for a thermal management device 10 that comprises the first connecting element 20.

The first port 60 and the second port 65 are connected by the first hollow volume 80. The first fluid FI can thus flow between the first port 60 and the second port 65. Likewise, the first fluid F1 can thus flow between a thermal management component 110 attached to the first port 60 and a thermal management component 110 attached to the second port 65. Owing to the exchange of thermal energy between the thermal management components 110 and the first fluid F1, thermal energy can thus be exchanged between the thermal management components 110 attached to the first port 60 and to the second port 65.

The first connecting element 20 produces a fluidic connection between the thermal management components 110 attached to the ports 60, 65 of the first connecting element 20. Depending on how many ports and hollow volumes are arranged in and on the first connecting element 20, and how these are arranged relative to one another, a large number of thermal management components 110 can be fluidically connected to one another. In particular, a circuit can be realized in which the thermal management components 110 attached to the first connecting element 20 are fluidically connected to one another.

The first base element 30 is produced here by casting. The first hollow volume 80 and the ports 60, 65 are provided by way of corresponding cores in the casting process. The dimensions of the first base element 30 in a direction perpendicular to the first plane E1 are greater in regions in which the first hollow volume 80 is situated than in regions in which no hollow volume is situated. The first hollow volume 80 and/or the ports 60, 65 may also be entirely or partially introduced after the casting process, for example by cutting manufacturing methods. The first base element 30 may also be designed as a solid component into which the first hollow volume 80 and the ports 60, 65 are introduced by way of a suitable production method (for example a cutting manufacturing method). Alternatively, the first base element 30 may be produced by generative manufacturing methods such as 3D printing or by any other manufacturing methods such as stamping of two plates, the two plates being later assembled to define hollow volumes created by the stamping or, in another alternative by extrusion.

The first base element 30 is preferably produced from aluminium. When selecting the material, consideration must be given in particular to the pressures that are to be expected in the first hollow volume 80 and the chemical resistance with respect to the first fluid F1. The aluminium embodiment allows a weight-saving design of the first base element 30, which can, without sustaining damage, withstand the pressures that are to be expected in the first hollow volume 80. The first base element 30 may also be produced from some other material, for example some other metal, fibre-reinforced plastic, or some other polymer.

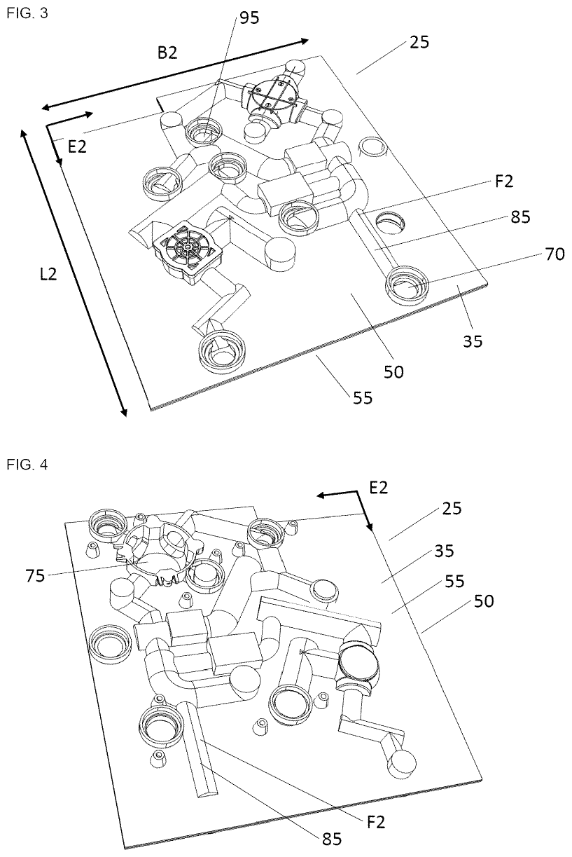

FIG. 3 shows a first perspective view of a second connecting element 25. The second connecting element 25 comprises a second base element 35. The second base element 35 is designed as a cuboidal and plate-like component. The second base element 35 extends in the direction of a second plane E2 and has a second width B2 and a second length L2. The extent of the second base element 35 in a direction perpendicular to the second plane E2 is considerably smaller than the extent of the second base element 35 in the second plane E2. The second base element 35 may also have a shape other than the cuboidal shape, for example a disc-like shape.

The second base element 35 may alternatively merely have the outline of a cuboid or of some other shape, wherein the second base element 35 may, in parts, have apertures. The second base element 35 may alternatively also have an outline other than the outline of a geometrical shape, that is to say may have a free-form design. This may be advantageous in particular in order to save material and thus costs and weight.

The second base element 35 has two surfaces that are oriented parallel to the second plane E2. One of said two surfaces is situated on a third side 50 of the second base element 35, and the other of the two surfaces is situated on a fourth side 55 of the second base element 35. The third side 50 is situated on that side of the second base element 35 which is situated opposite the fourth side 55.

The second connecting element 25 comprises a second hollow volume 85. The second hollow volume 85 is designed in the form of an elongate hollow volume within the second base element 35. The second hollow volume 85 has a circular cross section and has an elongate extent in the second plane E2. The second hollow volume 85 may also have some other cross section, and the cross section of the second hollow volume 85 may vary along the extent in the second plane E2.

The second hollow volume 85 extends in the second plane E2 in a meandering manner. The second hollow volume 85 may have a very limited, even approximately punctiform, extent in the second plane E2, or may extend in elongate or areal form over a major part of the second base element 35 in the second plane E2.

The second hollow volume 85 is suitable for receiving a medium such as a gas or a second fluid F2. The second hollow volume 85 thus forms a fluid path or a line for receiving the second fluid F2. The second fluid F2 can flow in the second hollow volume 85.

The second fluid F2 is for example a coolant fluid which is suitable for use in a cooling circuit and which is suitable for discharging thermal energy. The second fluid F2 is for example glycoled water, a dielectric fluid or oil. The second fluid F2 may also be some other material that can absorb and release thermal energy, for example also a refrigerant.

Aside from the second hollow volume 85, the second connecting element 25 may comprise further hollow volumes that may be separate from one another or connected to one another.

The second connecting element 25 furthermore comprises a third port 70 that is arranged on the third side 50 of the second base element 35. The third port 70 allows a thermal management component 110, such as a valve, a compressor, a heat exchanger, a temperature sensor or a pressure sensor, to be attached to or installed on the third port 70.

The third port 70 provides access to the second hollow volume 85, such that a thermal management component 110 attached to the third port 70 can be positioned in the fluid path defined by the second hollow volume 85. The thermal management component 110 can thus be fluidically connected by means of the third port 70 to the second hollow volume 85, such that the second fluid F2 that is conducted in the second hollow volume 85 can reach or enter the thermal management component 110. For example, a valve may be attached to the third port 70 in order to influence the flow of the second fluid F2 in the second hollow volume 85. It would also be possible, for example, for a heat exchanger to be connected by means of the third port 70 to the second hollow volume 85, such that the second fluid F2 can flow through the heat exchanger.

The third port 70 comprises a sealing element in order to prevent an escape of the second fluid F2 between the second base element 35 and a thermal management component 110 that is to be attached. The sealing element at the third port 70 may also be omitted. It is alternatively also possible for the thermal management component 110 to comprise a sealing element in order to seal off the thermal management component 110 with respect to the second base element 35.

The third port 70 allows not only the fluidic connection of the thermal management component 110 to the second hollow volume 85 but also the mechanical fastening of the thermal management component 110 to the third port 70. The thermal management component 110 may be fastened to the third port 70 for example using a fastening means such as a screw, or by way of a plug-in connection.

The third port 70 may alternatively be designed such that the thermal management component 110 that is to be attached is connected in thermally conductive fashion to the second fluid F2, but is not positioned in the fluid path defined by the second hollow volume 85. In this case, there is no fluidic connection between the thermal management component 110 attached to the third port 70 and the second hollow volume 85. The thermal management component 110 therefore does not come into direct contact with the second fluid F2 in the second hollow volume 85, but can exchange thermal energy with the second fluid F2. The third port 70 in this embodiment may also provide mechanical fastening of the thermal management component 110 to the second base element 35, for example using a fastening element such as a screw, or by way of a plug-in connection.

FIG. 4 shows a second perspective view of the second connecting element 25. The second connecting element 25 furthermore comprises a fourth port 75 that is arranged on the fourth side 55 of the second base element 35. The fourth port 75 allows a further thermal management component 110, such as a valve, a compressor, a heat exchanger, a temperature sensor or a pressure sensor, to be attached to or installed on the fourth port 75. As already described for the third port 70, the fourth port 75 allows the thermal management component 110 that is to be attached to be positioned in the fluid path formed by the second hollow volume 85. Alternatively, analogously to the statements made regarding the third port 70, the fourth port 75 may be designed such that the thermal management component 110 that is to be attached is connected in thermally conductive fashion to the second fluid F2 but is not positioned in the fluid path defined by the second hollow volume 85.

The second connecting element 25 may have further ports which are arranged at different locations on the third side 50 and/or the fourth side 55 and which are designed analogously to the statements made regarding the third port 70 and fourth port 75. Alternatively, the second connecting element 25 may only have ports that are all arranged only on one of the third side 50 and the fourth side 55. The thermal management components 110 that are to be attached to the ports are in this case attached only to one of the third side 50 and the fourth side 55. This can yield structural space advantages for the thermal management device 10 that comprises the second connecting element 25.

The third port 70 and the fourth port 75 are connected by the second hollow volume 85. The second fluid F2 can thus flow between the third port 70 and the fourth port 75. Likewise, the second fluid F2 can thus flow between a thermal management component 110 attached to the third port 70 and a thermal management component 110 attached to the fourth port 75. Owing to the exchange of thermal energy between the thermal management components 110 and the second fluid F2, thermal energy can thus be exchanged between the thermal management components 110 attached to the third port 70 and to the fourth port 75.

The second connecting element 25 produces a fluidic connection between the thermal management components 110 attached to the ports 70, 75 of the second connecting element 25. Depending on how many ports and hollow volumes are arranged in and on the second connecting element 25, and how these are arranged relative to one another, a large number of thermal management components 110 can be fluidically connected to one another. In particular, a circuit can be realized in which the thermal management components 110 attached to the second connecting element 25 are fluidically connected to one another.

The second base element 35 is, in an embodiment, produced by casting. The second hollow volume 85 and the ports 70, 75 are provided by way of corresponding cores in the casting process. The dimensions of the second base element 35 in a direction perpendicular to the first plane E1 are greater in regions in which the second hollow volume 85 is situated than in regions in which no hollow volume is situated. The second hollow volume 85 and/or the ports 70, 75 may also be entirely or partially introduced after the casting process, for example by cutting manufacturing methods. The second base element 35 may also be designed as a solid component into which the second hollow volume 85 and the ports 70, 75 are introduced by way of a suitable production method (for example a cutting or stamping manufacturing method). Alternatively, the second base element 35 may be produced by generative manufacturing methods such as 3D printing or as stamping of two plates, the two plates being later assembled to define hollow volumes created by the stamping or, in another alternative by extrusion.

The second base element 35 can also be produced from a polymer material such as polyphthalamide. When selecting the material, consideration must be given in particular to the pressures that are to be expected in the second hollow volume 85 and the chemical resistance with respect to the second fluid F2. The polymer material embodiment allows a weight-saving design of the second base element 35, which can, without sustaining damage, withstand the pressures that are to be expected in the second hollow volume 85. The second base element 35 may also be produced from some other material, for example a metal, fibre-reinforced plastic, or some other polymer.

The first connecting element 20 may furthermore comprise a fifth port 90, which is arranged on the first base element 30. The second connecting element 25 may furthermore comprise a sixth port 95, which is arranged on the second base element 35. The fifth port 90 and the sixth port 95 may be designed analogously to the statements made regarding the abovementioned ports 60, 65, 70, 75. The fifth port 90 and the sixth port 95 may be connected in each case to a thermal management component 110, such that the first fluid F1 and the second fluid F2 can flow through the thermal management component 110. In this case, the thermal management component 110 allows thermal energy to be exchanged between the first fluid F1 and the second fluid F2. Alternatively, the fifth port 90 and the sixth port 95 may be fluidically connected to one another by a hollow volume.

Fluidic and/or thermal coupling can thus be established between the first connecting element 20 and the second connecting element 25. For example, thermal energy can thus be exchanged between the first fluid F1 and the second fluid F2. Thermal energy can thus be exchanged between a cooling/heating circuit implemented using the first connecting element 20 and a cooling/heating circuit implemented using the second connecting element 25.

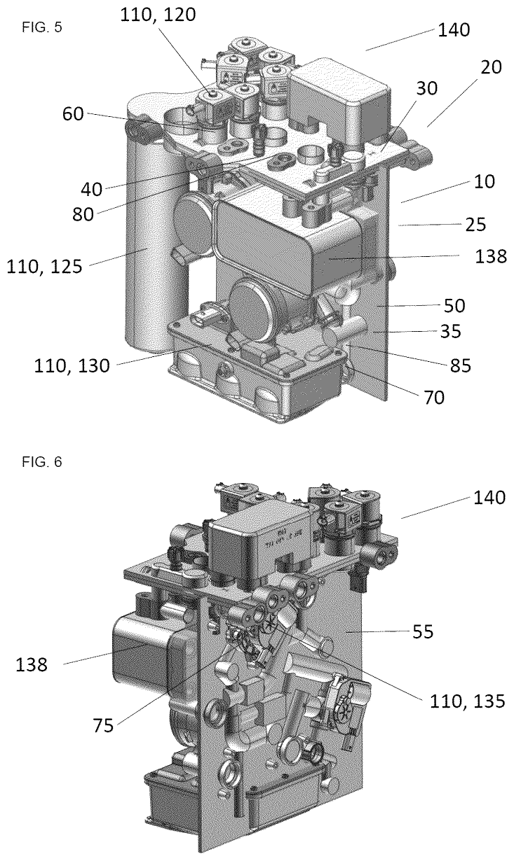

FIG. 5 shows a perspective view of a thermal management system 140. The thermal management system 140 may be installed in a vehicle 100, in particular in an electric or hybrid vehicle, though may also be used in other vehicles or systems. The thermal management system 140 comprises the thermal management device 10. The thermal management device 10 comprises the first connecting element 20 and the second connecting element 25. The first connecting element 20 and the second connecting element 25 are connected to a frame and are thus fastened to one another. Alternatively, the first connecting element 20 and the second connecting element 25 may also be fastened to one another using fastening elements such as screws, by way of a form-fitting connection such as a plug-in/slide connection, or by way of a cohesive connection such as adhesive bonding.

If required, the thermal management device 10 may also comprise more than two connecting elements, for example if it is sought to implement more than two heating/cooling circuits.

The first connecting element 20 and the second connecting element 25 may alternatively also be designed as an integral component, in particular if the first connecting element 20 and the second connecting element 25 are produced from the same material.

The first connecting element 20 and the second connecting element 25 are arranged at an angle with respect to one another. The dimensions of the first connecting element 20 and the second connecting element 25 are coordinated with one another such that the first width B1 corresponds to the second width B2. As compact a structural form of the thermal management device 10 as possible can thus be achieved, because the two connecting elements 20, 25 can thus be positioned flush with respect to one another, and there is therefore no wasted space in which no thermal management components 110 could be attached.

Owing to the angled arrangement of the two connecting elements 20, 25 with respect to one another, two volumes that are at least partially delimited by the connecting elements 20, 25 are defined. A first volume is delimited partially by the second side 45 of the first connecting element 20 and the third side 50 of the second connecting element 25. A second volume is delimited partially by the second side 45 of the first connecting element 20 and the fourth side 55 of the second connecting element 25.

The at least partially delimited volumes are suitable for receiving the thermal management components 110 that are to be attached to the thermal management device 10. This ensures that the thermal management components 110 are accommodated in a structural-space-optimized manner, because the outline of the thermal management device 10, which is predefined by the two connecting elements 20, 25, is not enlarged any further as a result of the thermal management components 110 being accommodated in the partially delimited volume.

The possible arrangement of the thermal management components 110 can yield further advantages. It is thus possible to easily form a housing that surrounds the entire thermal management system 140. The thermal management components 110 can thus be protected against external influences such as mechanical action or the action of media such as water.

Owing to the angled arrangement of the two connecting elements 20, 25 with respect to one another, the two connecting elements 20, 25 can in particular each be populated with thermal management components 110 from both sides, that is to say thermal management components 110 can be attached to the ports of the connecting elements 20, 25, and not only from one side in each case. The first connecting element 20 can be populated with thermal management components 110 on the first side 40 and on the second side 45, and the second connecting element 25 can be populated on the third side 50 and on the fourth side 55. In this way, the area of the connecting elements 20, 25 on which thermal management components 110 can be attached is enlarged. This makes it possible for a greater number of thermal management components 110 to be attached to the thermal management device 10, and offers greater freedom for the design of the connecting elements 20, 25 (for example positioning of the ports and hollow volumes) and arrangement of the thermal management components 110. Since more thermal management components 110 can be attached per connecting element 20, 25, and said thermal management components can be arranged in a more space-saving manner, the connecting elements 20, 25 can be of smaller dimensions. In this way, the thermal management device 10 can be made more compact.

The connecting elements 20, 25 are arranged at right angles with respect to one another. Most conventional thermal management components 110 are designed such that, when installed on a component such as the connecting elements 20, 25, said thermal management components project at right angles from said component. The right-angled arrangement of the two connecting elements 20, 25 with respect to one another allows thermal management components 110 that are attached to one of the two connecting elements 20, 25 to be arranged as close as possible to the respective other of the two connecting elements 20, 25. Therefore, as little structural space as possible is lost, and the thermal management device 10 can be of the most compact design possible.

The connecting elements 20, 25 are positioned relative to one another so as to form an approximately symmetrical T shape. The connecting elements 20, 25 could however also be arranged as an asymmetrical T or as an L, depending on what thermal management components 110 are intended to be attached to the thermal management device 10. The asymmetrical T shape is suitable in particular if it is intended to attach thermal management components of different size. Owing to the asymmetrical T shape, the two at least partially delimited volumes are of different size, such that thermal management components 110 of different size can be suitably received. Analogously, the symmetrical T shape is suitable if the thermal management components 110 that are to be accommodated are of approximately similar dimensions.

The thermal management components 110 of the thermal management system 140 may alternatively also be arranged only on one of the first side 40 and the second side 45 and/or one of the third side 50 and the fourth side 55. For example, in an L arrangement, the second connecting element 25 may preferably be populated with thermal management components 110 only from one of the third side 50 and the fourth side 55. This makes it possible in particular for large thermal management components 110 to be arranged on the second connecting element 25 in an expedient manner in terms of structural space. In the L arrangement, the first connecting element 20 may be populated with thermal management components 110 only from one, or from both, of the first side 40 and the second side 45. Analogously, the first connecting element 20 may be populated with thermal management components 110 only from one of the first side 40 and the second side 45, wherein the second connecting element 25 is populated with thermal management components 110 from both of the third side 50 and the fourth side 55. A further reason for populating the connecting elements 20, 25 only from one side may for example be the accessibility to the thermal management system 140 when it has been installed in the vehicle 100. For example, the thermal management system 140 in the vehicle may be accessible only from certain sites. Populating only these sides of the connecting elements 20, 25 with thermal management components 110 can allow the thermal management components 110 to be exchanged in the vehicle without the need to uninstall the entire thermal management system 140.

The thermal management system 140 furthermore comprises a first thermal management component 120, which is attached to the first port 60. The first thermal management component 120 is a valve for influencing the flow of the first fluid F1 in the first hollow volume 80. The thermal management system 140 furthermore comprises a second thermal management component 125, which is attached to the second port 65. The second thermal management component 125 is a receiver drier, which extracts inter alia moisture and contaminants from the first fluid. The thermal management system 140 furthermore comprises a third thermal management component 130, which is attached to the third port 70. The third thermal management component 130 is a heater for heating the second fluid F2.

The thermal management system 140 furthermore comprises a fifth thermal management component 138, which is attached to the fifth port 90 and to the sixth port 95. The fifth thermal management component 138 is a chiller for transferring thermal energy between the first fluid F1 and the second fluid F2.

FIG. 6 shows a second perspective view of the thermal management system 140. The thermal management system 140 furthermore comprises a fourth thermal management component 135, which is attached to the fourth port 75. The fourth thermal management component 135 is a valve for influencing the flow of the second fluid F2 in the second hollow volume 85.

The thermal management system 140 as illustrated in FIGS. 5 and 6 may alternatively comprise additional thermal management components 110 or thermal management components 110 other than those mentioned above. The thermal management components 110 may for example be valves for influencing the flow of the fluids F1, F2, pumps, heat exchangers, heaters, compressors, temperature sensors, pressure sensors or flow sensors.

The thermal management components 110 may be attached either to only one port or to multiple ports. For example, one port may be sufficient for a temperature or pressure sensor, whereas, in general, more than one port is necessary for a heat exchanger or a pump through which flow must pass.

Thermal management components 110 such as heat exchangers, pumps or heaters can be varied in terms of their power approximately proportionally to their dimensions. For example, a heat exchanger, if doubled in length, can exchange approximately twice the amount of thermal energy between two fluids flowing through the heat exchanger. The flexible arrangement of the connecting elements 20, 25 with respect to one another yields freedom for the dimensioning of the thermal management components 110 in accordance with the demands placed thereon.

The thermal management components 110 of the thermal management system 140 are accessible from all sides of the thermal management system 140. This can be advantageous if it is necessary to uninstall and reinstall thermal management components 110 during the service life of the vehicle 100, because the accessibility for the exchange operation is thus improved.

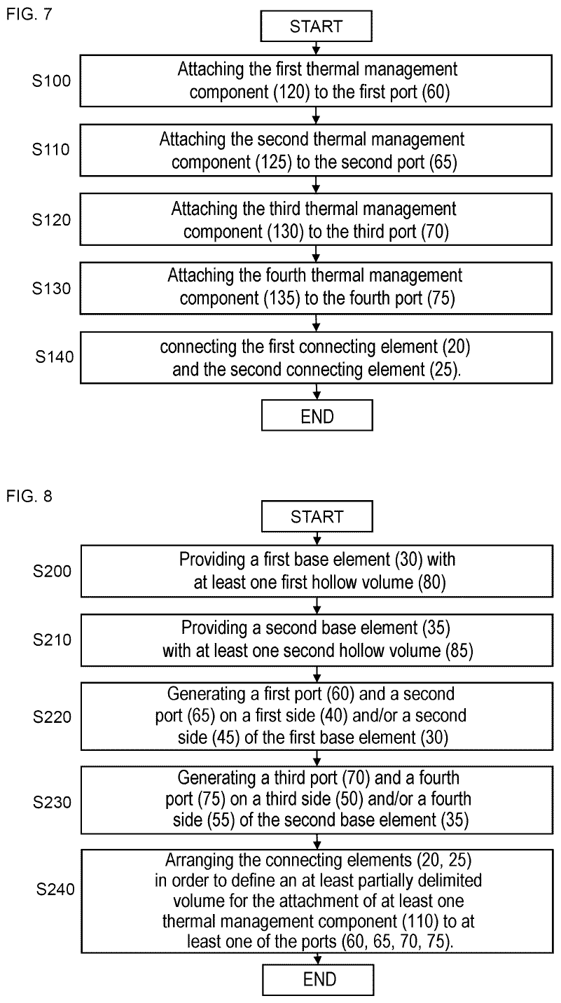

FIG. 7 shows a flow diagram of a method for assembling the thermal management system 140. The method comprises attaching S100 the first thermal management component 120 to the first port 60, attaching S110 the second thermal management component 125 to the second port 65, attaching S120 the third thermal management component 130 to the third port 70, and attaching S130 the fourth thermal management component 135 to the fourth port 75.

The attachment S100, S110, S120, S130 of the thermal management components 120, 125, 130, 135 to the ports 60, 65, 70, 75 may comprise different steps depending on the design of the ports 60, 65, 70, 75 and the thermal management components 120, 125, 130, 135. For example, a male attachment part of the thermal management components 120, 125, 130, 135 can be inserted into a female receiving part of the ports 60, 65, 70, 75. Furthermore, the method steps S100, S110, S120 and S130 may comprise a further step for the mechanical fixing of the thermal management components 120, 125, 130, 135 to the ports 60, 65, 70, 75, for example the fastening of the thermal management components 120, 125, 130, 135 to the ports 60, 65, 70, 75.

In step S140, the first connecting element 20 and the second connecting element 25 are connected to one another if the first connecting element 20 and the second connecting element 25 are not designed as an integral component. The process of connecting the first connecting element 20 and the second connecting element 25 may for example involve inserting a part of one of the first connecting element 20 and of the second connecting element 25 into a part of the other of the first connecting element 20 and of the second connecting element 25 in order to produce a form-fitting connection. Step S140 may alternatively also include connecting the first connecting element 20 and the second connecting element 25 by means of an additional component such as a frame. Here, the frame is fastened both to the first connecting element 20 and to the second connecting element 25 in order to connect the two connecting elements 20, 25 to one another.

The connection of the first connecting element 20 and the second connecting element 25 is preferably releasable. It is furthermore advantageous to carry out step S140 after the steps S110, S120, S130, S140. The thermal management components 120, 125, 130, 135 can thus be attached to the ports 60, 65, 70, 75 without the freedom for attaching the thermal management components 120, 125, 130, 135 to one of the first connecting element 20 and the second connecting element 25 being restricted by the respective other of the first connecting element 20 and the second connecting element 25.

FIG. 8 shows a flow diagram of a method for producing the thermal management device 10. In step S200, the first base element 30 is provided, which comprises at least the first hollow volume 80. In step S210, the second base element 35 is provided, which comprises at least the second hollow volume 85. The first base element 30 with the first hollow volume 80 and the second base element 35 with the second hollow volume 85 may be produced using different manufacturing methods, as described above.

In step S220, the first port 60 and the second port 65 are generated on the first side 40 and/or the second side 45 of the first base element 30. In step S230, the third port 70 and the fourth port 75 are generated on the third side 50 and/or the fourth side 55 of the second base element 35. The ports 60, 65, 70, 75 may be generated on the base elements 30, 35 using different manufacturing methods, as described above.

In step S240, the first connecting element 20 and the second connecting element 25 are arranged relative to one another such that a volume at least partially delimited by the first connecting element 20 and the second connecting element 25 is defined. In the volume, the at least one thermal management component 110 can be attached to at least one of the ports 60, 65, 70, 75.

### LIST OF REFERENCE DESIGNATIONS

10 Thermal management device
20 First connecting element
25 Second connecting element
30 First base element
35 Second base element
40 First side
45 Second side
50 Third side
55 Fourth side
60 First port
65 Second port
70 Third port
75 Fourth port
80 First hollow volume
85 Second hollow volume
90 Fifth port
95 Sixth port
100 Vehicle
110 Thermal management components
120 First thermal management component
125 Second thermal management component
130 Third thermal management component
135 Fourth thermal management component
138 Fifth thermal management component
140 Thermal management system
B1 First width
B2 Second width
E1 First plane
E2 Second plane
F1 First fluid
F2 Second fluid
L1 First length
L2 Second length
S100 Attaching the first thermal management component
S110 Attaching the second thermal management component
S120 Attaching the third thermal management component
S130 Attaching the fourth thermal management component
S140 Connecting the first connecting element and the second connecting element
S200 Providing a first base element
S210 Providing a second base element
S220 Generating a first port and a second port
S230 Generating a third port and a fourth port
S240 Arranging the connecting elements

1. A thermal management device for an electric or hybrid vehicle, the thermal management device comprising:
a first connecting element, comprising:
a first base element with a first side and a second side;
at least one first port, arranged on the first side or the second side, and
one second port, arranged on the first side or the second side; and
at least one first hollow volume that extends between the at least first port and second port; and
a second connecting element, comprising:
a second base element with a third side and a fourth side;
at least one third port, arranged on the third side or the fourth side, and one fourth port, arranged on the third side or the fourth side; and
at least one second hollow volume that extends between the at least third port and fourth port;
wherein the first connecting element and the second connecting element are positioned at an angle with respect to one another, such that an at least partially delimited volume for the attachment of at least one thermal management component to the first connecting element or the second connecting element is defined.

2. The thermal management device according to claim 1,
wherein at least one of the ports allows the attachment of at least one thermal management component in order to position the thermal management component in a fluid path defined by the hollow volumes.

3. The thermal management device according to claim 1,
wherein at least one of the ports allows the attachment of at least one thermal management component in order to position the thermal management component separately from the fluid path defined by the hollow volumes and in order to exchange thermal energy with a first fluid in the first hollow volume or with a second fluid in the second hollow volume.

4. The thermal management device according to claim 1,
wherein one of the first port and the second port is arranged on the first side, and the other of the first port and the second port is arranged on the second side.

5. The thermal management device according to claim 1,
wherein one of the third port and the fourth port is arranged on the third side and the other of the third port and the fourth port is arranged on the fourth side.

6. The thermal management device according to claim 1,
wherein the first connecting element and the second connecting element are arranged orthogonally with respect to one another.

7. The thermal management device according to claim 1,
wherein the first base element is of plate-like form with the integrated fluid path that is defined by the first hollow volume that extends in the first plane, and
wherein the second base element is of plate-like form with the integrated fluid path that is defined by the second hollow volume that extends in the second plane.

8. The thermal management device according to claim 1,
wherein at least one of the ports is attached to or integral with, the first base element or the second base element.

9. The thermal management device according to claim 1,
wherein the first connecting element and the second connecting element are connected to each other.

10. The thermal management device according to claim 1,
wherein the first connecting element comprises a fifth port and the second connecting element comprises a sixth port,
wherein the fifth port and the sixth port are fluidically connected.

11. The thermal management device according to claim 1,
wherein the first connecting element and the second connecting element are an integral element.

12. The thermal management device according to claim 1,
wherein the thermal management components are at least one of: a valve, a pump, a heat exchanger, a temperature sensor or a pressure sensor.

13. The thermal management device according to claim 1,
wherein at least one of the connecting elements has at least one of the thermal management components on each of its sides.

14. A thermal management system, comprising:
the thermal management device according to claim 1; and at least one of:
a first thermal management component attached the first port,
a second thermal management component attached to the second port,
a third thermal management component attached to the third port, and
a fourth thermal management component attached the fourth port;
wherein the thermal management components are at least one of:
a valve, a pump, a heat exchanger, a temperature sensor or a pressure sensor.

15. (canceled)
